(19) United States
(12) Patent Application Publication
(10) Pub. No.: US 2014/0240960 A1
(43) Pub. Date: Aug. 28, 2014

(54) DISPLAY HAVING A BACKPLANE WITH AN EDGE SURFACE THAT MAKES AN ANGLE WITH THE TOP SURFACE

(71) Applicant: HEWLETT-PACKARD DEVELOPMENT COMPANY, L.P., Houston, TX (US)

(72) Inventors: David A. Fattal, Palo Alto, CA (US); Marco Fiorentino, Palo Alto, CA (US); Zhen Peng, Palo Alto, CA (US)

(73) Assignee: Hewlett-Packard Development Company, L.P., Houston, TX (US)

(21) Appl. No.: 13/778,206

(22) Filed: Feb. 27, 2013

(51) Int. Cl. F21V 33/00; B23Q 41/00

(52) U.S. Cl. CPC F21V 33/00; B23Q 41/00
USPC 362/97.1; 29/407.09

(57) ABSTRACT

A display is disclosed. The display has a backplane with a top surface and an edge surface. The edge surface makes an angle α with respect to the top surface. An optical system is used to create a collimated light beam that is coupled to the edge surface. The collimated light beam makes an angle β with respect to the top surface. The optical axis of the light beam has a refracted angle β′ with respect to the top surface. Angles α and β are selected such that β′ is no smaller than α.

### BACKGROUND

Some displays use backlighting to illuminate the display surface. The light used to backlight the display is typically coupled into an edge of the display.

### BRIEF DESCRIPTION OF THE DRAWINGS

FIG. 1 is an isometric view of an example display 100.

FIG. 2 is a partial side view of display 100.

FIG. 3A is an example backplane 308.

FIG. 3B shows a light beam 306 entering backplane 308 through edge surface 304.

FIG. 4 is an enlarged view of the example backplane 308.

FIG. 5 is an example graph of a plot of beam angle β vs. wedge angle α.

FIG. 6 is an example flow chart for coupling a collimated light beam into a backplane.

### DETAILED DESCRIPTION

Displays are devices used to display electronic images to users. Some displays produce light used to create the image, for example a cathode ray tube (CRT). Other displays produce light to illuminate the elements in the display that create the image, for example liquid crystal displays (LCD). Some displays use back lighting to illuminate the surface of the display, for example touch screens. Backlit displays typically couple one or more light beams into the backplane of the display through a side edge of the backplane. The backplane is the layer in the display that channels or directs the light along the surface of the display.

When coupling a light beam into the backplane of a display through a side edge, the refracted beam angle and the beam height inside the backplane of the display determines when the backplane is uniformly illuminated. The refracted beam angle inside the backplane is dependent on the angle the beam makes with the top surface of the backplane, the angle the edge surface makes with the top surface of the backplane and the index of refraction of the backplane material. When the edge surface of the backplane is at a 90 degree angle with respect to the top surface of the backplane, the refracted angle of the beam inside the backplane cannot be adjusted such that the back plane is uniformly illuminated. By angling the side edge with respect to the top surface, the refracted angle of the beam inside the backplane can be adjusted such that the back plane is uniformly illuminated.

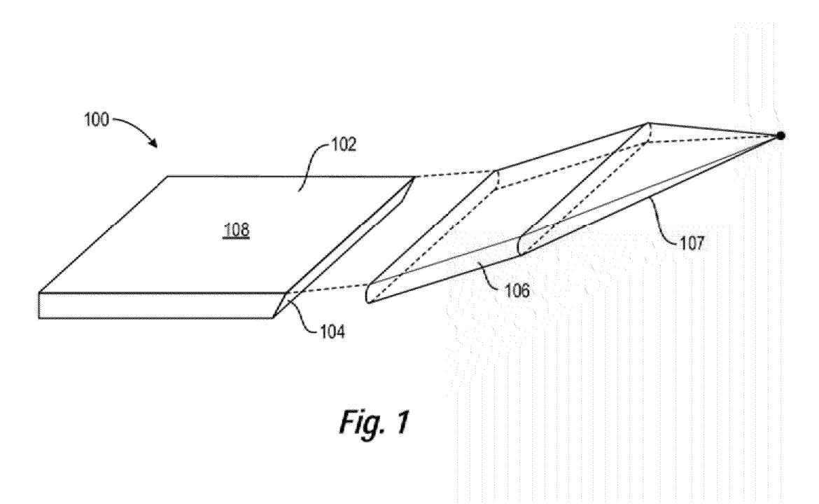

The FIG. 1 is an isometric view of an example display 100. Display 100 comprises a backplane 108, a collimated beam of light 106 and an optical system 107. Backplane 108 is a thin block or slab of transparent material, for example Silicon Nitride (SiN), glass, or quartz, plastic, Indium Tin Oxide (ITO), or the like. A slab of material has a top surface, and a bottom surface parallel with the top surface. A slab of material has a thickness that is much smaller than the width or length of the material. A slab typically is square or rectangular in shape, but can have other shapes, for example circular, octagonal or the like.

Backplane 108 typically has a thickness in the range between 1 and 10 mm. Backplane 108 has a top surface 102, a bottom surface and an edge surface 104. The bottom surface of the backplane is parallel with the top surface. The edge surface makes a non-ninety degree angle (also called a wedge angle) with the top surface. Optical system 107 produces the collimated beam of light 106 using one or more lenses and/or mirrors. In some examples, optical system has a single light source (as shown). In other examples multiple light sources may be used to create the beam of collimated light 106. The collimated beam of light enters the backplane though edge surface 104. The collimated beam of light substantially fills the edge surface 104.

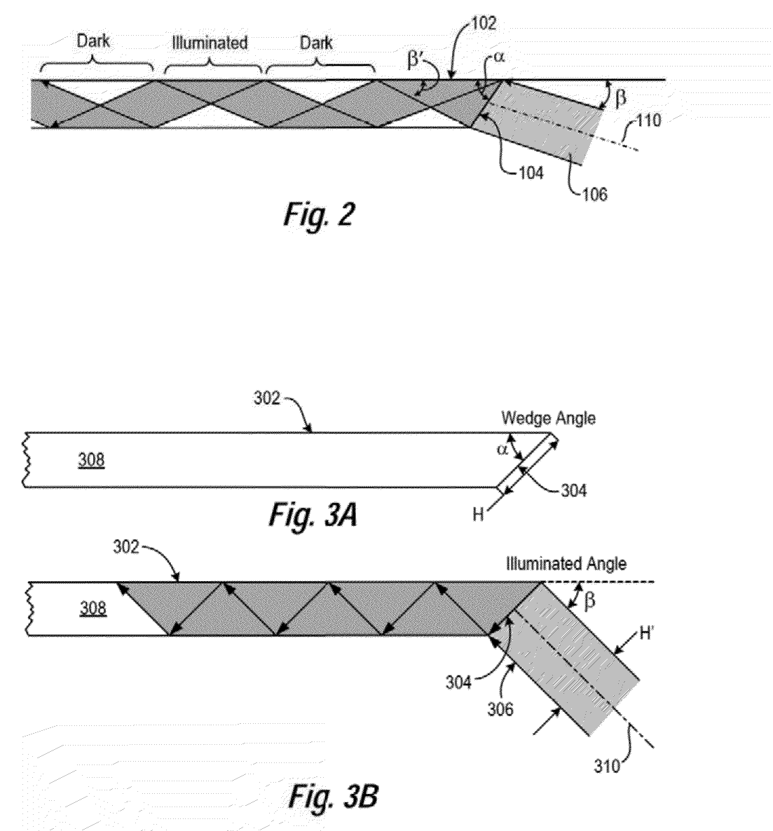

FIG. 2 is a partial side view of display 100. FIG. 2 shows beam 106 entering the backplane through edge surface 104. Beam 106 has a centerline 110. Edge surface 104 makes a wedge angle α with respect to the top surface 102. Beam 106 makes an angle β with respect to the top/bottom surface. Beam 106 makes a refracted angle β′ with the top surface 102, inside the backplane. Once the beam enters the backplane, the beam propagates through the backplane by reflecting off the top and bottom surfaces using total internal reflection. When the refracted angle β′ is too small, dark and light (illuminated) areas are formed on the top surface 102 of the backplane as the beam propagates down the backplane. The dark areas are because of gaps in the illumination from the beam 106. The dark areas form in locations where no part of the beam contacts the top surface 102.

FIG. 3A is an example backplane 308. Backplane 308 has a top surface 302, a bottom surface parallel with the top surface 302, and an edge surface 304. Edge surface 304 makes a wedge angle α with respect to the top surface 302. Edge surface has a thee height of H. FIG. 3B shows a light beam 306 entering backplane 308 through edge surface 304. Light beam 306 makes an angle β with respect to the top surface 302 of backplane 108. Light beam 306 has a beam height H′ that substantially equals the edge surface face height such that the beam fills the edge surface 304. When angles α and β are correctly selected, the beam 306 will propagate down the backplane 308 without leaving any gaps in illumination as shown (i.e the beam contacts all areas of the top surface 302 in the direction of propagation).

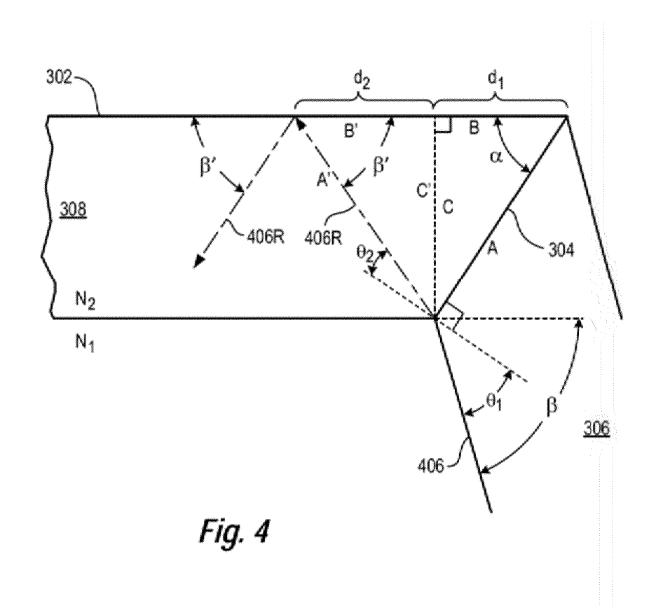

FIG. 4 is an enlarged view of the example backplane 308. The edge surface 304 makes a wedge angle α with respect to the top surface 302 of the backplane 308. A light ray 406 at the bottom of the light beam enters the backplane 308 at the bottom corner of edge surface 304. Light ray 406 makes an angle β with respect to the top surface 302 of backplane 308. When light ray 406 is not perpendicular to the edge surface 304 (as shown), light ray 406 gets refracted by edge surface 304. Refracted light ray 406R makes an angle β′ with respect to the top surface of the backplane. Distance d1 is the length of the bottom of a right triangle made by the top surface 302 and the edge surface 304 of backplane. Distance d2 is the length of the bottom of a right triangle made by refracted light ray 406R and the top surface of the backplane 308.

When β′ equal to α, distance d1 will equal distance d2 because the two triangles are equal (triangle ABC is equal to triangle A′B′C′). Therefore when β′ is equal to α, the edges of the beam inside the backplane will just meet along the top surface of the backplane as the beam propagates down the backplane. Therefore the backplane 308 will have uniform illumination along the top surface 302.

When β′ is smaller than α, the beam will have gaps in illumination as it travels down the backplane. These gaps form dark areas in the illumination of the top surface of the backplane. The gaps in illumination form a non-uniform illumination along the top surface of backplane 308. When β′ greater than α, the beam will overlap along the top surface of the backplane as it travels down the backplane.

Angle β and β′ are related by Snell's law, the index of refractive of the two materials and angle α. In this case the first material is air, which has a refractive index of 1. Setting β′ equal to α and using N as the index of refraction of the backplane 308, we can solve for β.

sin β=cos α\sqrt{1−(N cos 2α)²}−N cos 2α*sin α Equation 1

In addition the angle β′ (which equals angle α) must be kept small enough to satisfy the total internal reflection constraint. The refracted beam angle measured with respect to a line perpendicular to the top surface (i.e. 90−β′) should be larger than the critical angle for total internal reflection. The critical angle is measured with respect to a line perpendicular to the top surface. The critical angle θ_{c} is equal to arcsin (1/N), where N is the index of refraction of the backplane. Therefore β′ set less than 90−θ_{c}.

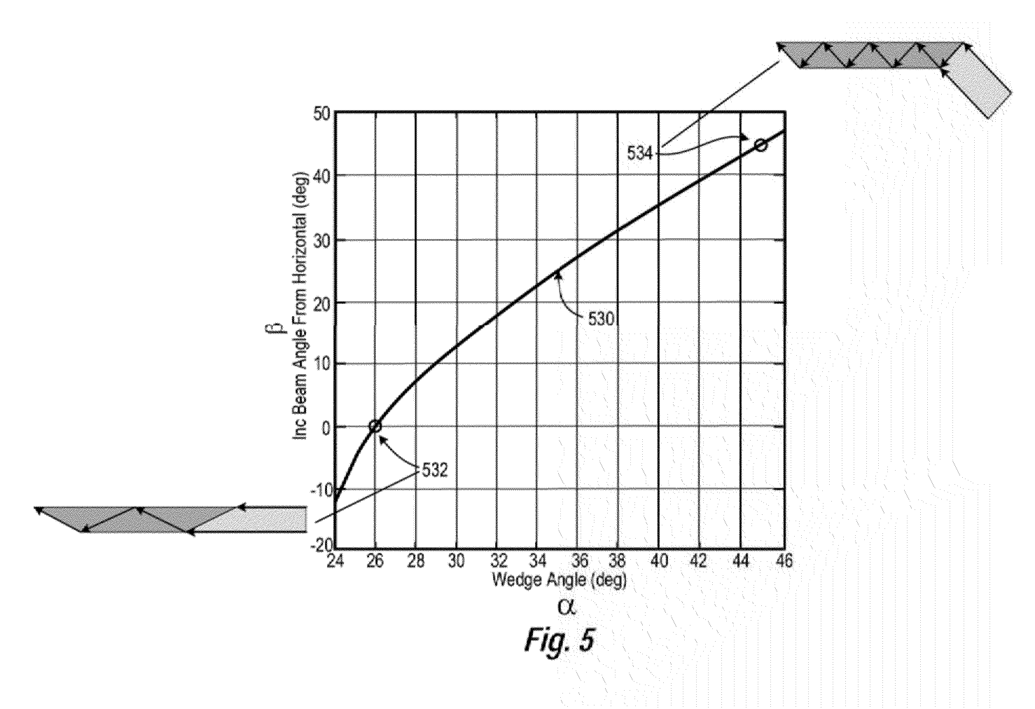

FIG. 5 is an example graph of a plot of beam angle β vs. wedge angle α. The vertical axis is the angle β the beam makes with respect to the top surface of the backplane. The horizontal axis is the wedge angle α that the side surface makes with respect to the top surface of the backplane. Line 530 is the plot of equation 1 where β′ is equal to α and with an index of refraction of the backplane set to 1.46. Two places along line 530 are identified.

Point 532 is where the beam angle β is zero (i.e. the beam is parallel with the top surface of the backplane). The wedge angle α for point 532 is 26 degrees. Because the beam enters the backplane parallel with the top surface of the backplane, a display can be fabricated using planer geometry (i.e. all the components can be manufactured/assembled in the same plane). Point 534 is where both the beam angle β and the wedge angle α are at 45 degrees. This allows the beam to enter the side surface of the backplane at a 90 degree angle (i.e. no refraction of the beam as it enters the backplane). When the wedge angle α of the edge surface is equal to 90 degrees, there is no angle β that can be chosen such that angle β′ is greater than or equal to angle α.

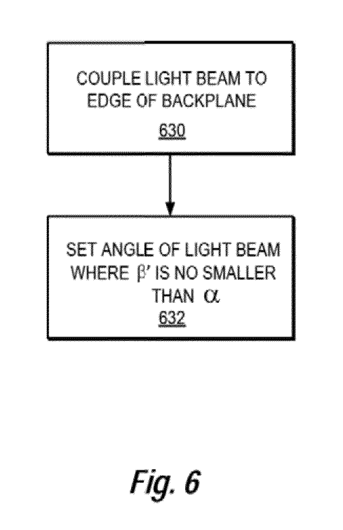

FIG. 6 is an example flow chart for coupling a collimated light beam into backplane. At step 630 a collimated light beam is coupled to an edge surface of a back plane where the edge surface makes an angle α with the top surface of the backplane. The collimated light beam making an angle β with respect to the top surface and a refracted angle β′ with respect to the top surface. At step 632 angle α and angle β are selected such that β′ is no smaller than α.

What is claimed is:

1. A display, comprising:
backplane, the backplane shaped as a slab of transparent material;
the backplane having a top surface and at least one edge surface, where the at least one edge surface makes an angle α with the top surface;
an optical system to produce a light beam of collimated light, the beam of collimated light entering the backplane at the at least one edge surface, the optical system haying an optical axis where the optical axis makes an angle β with respect to the top surface;
the optical axis having a refracted angle β′ with respect to the top surface; and
angle α and angle β are selected such that angle β′ is no smaller than α.

2. The display of claim 1, where β′ is equal to α.

3. The display of claim 1, where the backplane is fabricated from a material selected from the group: Silicon Nitride (SIN), glass, quartz, plastic, or Indium Tin Oxide (ITO).

4. The display of claim 1, where angle β equals zero.

5. The display of claim 1, where both the angle β and the angle α equal 45 degrees.

6. The display of claim 1, where a height of the light beam is substantially equal to a face height of the at least one edge surface.

7. The display of claim 1, where β′ is set less than 90−θ_{c} where θ_{c} is a critical angle of the backplane.

8. A Method of fabricating a display, comprising:
aligning an optical system to couple a beam of collimated light, formed by the optical system, into a backplane through an edge surface of the backplane, the backplane having a top surface, where the edge surface makes an angle α with the top surface;
the optical system having an optical axis where the optical axis makes an angle β with respect to the top surface;
the optical axis of the light beam having a refracted angle β′ with respect to the top surface; and
selecting angle β such that β′ is no smaller than α.

9. The method of claim 8, where β′ is equal to α.

10. The method of claim 8, where the backplane is fabricated from a material selected from the group: Silicon Nitride (SiN), glass, quartz, plastic, or Indium Tin Oxide (ITO).

11. The method of claim 8, where angle β equals zero.

12. The method of claim 8, where both the angle β and the angle α equal 45 degrees.

13. The method of claim 8, where a height of the light beam is substantially equal to a face height of the edge surface.

14. The method of claim 8, where β′ is set less than 90−a critical angle θ_{c} of the backplane.

15. A method of illuminating a display having a backplane, comprising:
coupling a beam of collimated light into the backplane through an edge surface of the backplane, the backplane having a top surface, where the edge surface makes an angle a with the top surface and where the beam of collimated light makes an angle β with respect to the top surface;
the light beam haying a refracted angle β′ with respect to the top surface; and
selecting angle β such that β′ is no smaller than α.
